(19) United States
(12) Patent Application Publication
(10) Pub. No.: US 2014/0272824 A1
(43) Pub. Date: Sep. 18, 2014

(54) SYSTEM AND METHOD FOR IMPROVING SPELLING AND VOCABULARY

(71) Applicant: Jonathan Marceau, Clawson, MI (US)

(72) Inventor: Jonathan Marceau, Clawson, MI (US)

(21) Appl. No.: 14/212,029

(22) Filed: Mar. 14, 2014

Related U.S. Application Data
(60) Provisional application No. 61/788,502, filed on Mar. 15, 2013.

(51) Int. Cl. G09B 5/00

(52) U.S. Cl. CPC G09B 5/00
USPC 434/169

(57) ABSTRACT

A computer implemented system and method for teaching and evaluating language competency is disclosed and provides for the sorting, selection, testing and teaching of words based on previous demonstrated mastery and common word characteristics.

### CROSS REFERENCE TO RELATED APPLICATIONS

The present disclosure claims priority to U.S. Provisional Application No. 61/788,502 filed Mar. 15, 2013.

### BACKGROUND

This disclosure generally relates to a system and method for evaluating and teaching spelling and vocabulary. More specifically, this disclosure relates to a web-based system utilized by teachers and students to tailor spelling instruction to a specific student or group of students based on ability.

Computer programs that are intended to teach spelling typically consist of a group of words chosen by a teacher that are presented to a student in various forms. Students then take tests to demonstrate competency for the chosen groups of words. Such systems are not tailored to an individual student's ability, nor do such systems provide a systematic method of continually challenging a student based on current ability and a target goal ranking or competency.

Accordingly, it is desirable to design and develop a system for teaching spelling that tailors instruction to a student's ability and that defines a course of study that progresses that student to target ranking and competency.

### SUMMARY

A computer implemented system and method for teaching and evaluating language competency is disclosed and provides for the sorting, selection, testing and teaching of words based on previous demonstrated mastery and common word characteristics.

The example method includes the steps of inputting information relating to at least one student into a computing system including a database, and testing the at least one student to determine an initial level of competency and ability utilizing the computing system. The method further includes defining a word list for study based on the level of competency and ability determined during testing. The method further includes tracking progress of demonstrated competency and ability and tailoring subsequent word lists based on the progress tracked and documented in the system and database.

An example system for teaching spelling and vocabulary is disclosed and includes database accessible as part of computer system, wherein the database includes listings of words categorized by common characteristics and data sortable by student that is indicative of progress relating to student mastery of the listing of words and a student interface for providing accessing by a student to the database. The system further includes a teacher interface to the database for providing access by a teacher to input student information and track mastery of the listing of words. The teacher interface to the database includes reports for defining and categorizing data resulting from activities and testing conducted by students to determine progress and for tailoring future word lists based on determined progress.

Although the different examples have the specific components shown in the illustrations, embodiments of this disclosure are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWINGS

FIG. 1 is a schematic view of an example computer implemented system for teaching and evaluating language competency.

FIG. 2 is a flow diagram of illustrating example method steps for testing and evaluating language competency.

### DETAILED DESCRIPTION

Referring to FIG. 1 a system 10 and method for improving spelling and/or vocabulary is disclosed. The disclosed system 10 is computer based and can be implemented as part of a website or software run on a computer system 32. The system 10 includes a database 12 including wordlists, activities 20, and testing processes that are accessed by a student. The system 10 is accessed through a teacher or instructor interface 30 and through a student interface 28. Although this disclosure refers to a teacher by way of example, it is within the contemplation of this disclosure that parents, tutors or any other instructor could use and apply the disclosed system and methods.

The Teacher interface 30 provides for information 24 to be input on each student or class. The information 24 may include student name, age, country and zip code. Moreover, information 24 specific to each student such as grade level, birthdate, gender along with any other data that would aid in describing each student.

A Teacher will also define the number and types of words that are to be included for instructing each student, or group of students. A Teacher through the teacher interface 30 can define the period of spelling tests 22 and a number of words that are worked on for that period. For example, a teacher may designate twenty (20) words for a quiz or testing each week.

Once the teacher has set up access for each student, individual students will access the system 10 through a student interface 28. As appreciated, the student interface 28 is through a typical computer system 32 including a keyboard and mouse. Moreover, the student interface 28 will include speakers or headphones to play back an audio file for the activities 20 and testing. Testing is conducted by the student listening to an audio file pronunciation of a spelling word and/or sample sentence then inputting spelling of the word through the keyboard.

The initial log in by the student will include an initial quiz known as an inventory to access the spelling and vocabulary ability of the student. The quiz includes words selected from the database 12 to determine a spelling ability and competency of each student individually. The inventory is implemented by playing audio through either speakers or headphones where words are spoken and the student is prompted to input the word with the keyboard. The inventory may include a substantial number of words, for example up to about one-hundred-fifty (150) words. The inventory provides an idea of the spelling ability and/or vocabulary ability of the student. The inventory is administered to students of all ability levels.

The inventory is utilized to determine the ability and competency of the student and is stored within the system 10 and database 12 for each individual student. Moreover, results can be accessed and sorted by student, grade class or any other identifying characteristic to enable the teacher to gauge and determine overall progress and progress by any subgroup that may prove useful for improving the learning progress.

Once each student's spelling and/or vocabulary ability is determined, the system 10 defines a set of words for that student to begin work. The words are selected from a stored word list 14 that are graded or scored to correspond with the students beginning ability as determined by the inventory.

Each word in the database 12 of spelling words is graded or leveled to define a specific grade or mastery level. The words begin at a very initial level of learning and move on to words that are defined by grade level. Each word in the database 12 includes a grade ability level, pattern type(s), word type characteristics, number of syllables, characters of each syllable, number of characters, alternate spellings, language(s) of origin, and audio files of the spoken word, definition and sample sentences. The words then are sorted depending on the student's level as determined by the initial inventory by grade ability and pattern type.

In one example, the database associates a decimal number with each word based on grade and fraction of grade level. For example a word that should be within the capability of a third grader after one fourth (¼) of the school year is indicated as 3.25. Three (3) indicates the grade and point two five (0.25) indicates the progress throughout the school year. Another word may have a numeric rating of 4.07 to indicate a word that is appropriate for a fourth grader that has completed seven percent (7%) of the school year. As appreciated further iterations and number combinations can be utilized to represent words belonging to other groups and rankings.

If the inventory indicates that the student has problems with words of a specific pattern type, similar words can be included in the student's individualized word lists 14. Moreover, similar patterned words are also included that are in the grade level ability indicated by the inventory.

Once the students beginning level of ability are determined, individualized word lists 14 are formed through student interaction with the student interface to challenge the student and move the student toward further grade level ability and mastery. The student could then select from many different related language activities 20 that utilize the words selected from the database 12. The activities 20 enable the student to interact with the words in different settings to develop a mastery of the words on the word list 14. The activities 20 are defined within the system 10 and can be automatically implemented and accessed or selected by the teacher for specified group of students or class.

The student would then be tested on the words after a time defined by the teacher. Testing is conducted by the student through the student interface 28 where an audio file of each word and/or sample sentence in the current word list 14 is spoken. The student inputs the spelling of the words and the results 16 are stored in the database 12 and identified by student.

Testing may also be conducted by presenting a student with a sample sentence that includes a blank for a selected one if the spelling words. The blank within the sentence provides not only for the testing of the spelled word, but also to test the student's knowledge of how the word is used in context. The test could be conducted with the student filling in the indicated blanks with the proper word. The test could also be conducted by having a student listen to the different words from that period's group of words and then typing in the one that the student determines fits best in the particular sentence. This method provides for testing of the spelling, meaning, and proper usage of each word.

If a word is correctly spelled, the next word in the word list 14 is presented. If a word is not spelled correctly, the correct spelling is provided by the system 10 either visually and/or audibly. The misspelled word is indicated and associated with the student within the database 12.

The system may also include a feature for forcing a re-quiz in response to a very high percentage of incorrectly spelled words that are indicative of a lack of effort by a student. For example, if during the testing process the student is incorrect a proportionally large amount (for example above 70-80%) the quiz could be automatically stopped and a re-quiz be implemented. Above a certain percentage of incorrect answers is often an indication that a student is not setting forth an effort required. Accordingly, the system can be set to recognize indicators of low effort and either institute a re-quiz, or alert the teacher. The teacher could then determine if a re-quiz is required or if the student should be allowed to continue.

Data 18 on correctly and incorrectly spelled words is stored in the database 12 and associated with the student and student data of birthdate and grade. The misspelled words can be gathered for each student for study for a time indicated by the teacher. The system 10 is capable of listing the words in a printable format for the student to use for study.

The system 10 provides for testing of the students after study and activity to determine a mastery or ability of spelling. The tests 22 are automatically corrected and results 16 of each students test and progress are accessible by the teacher as a report 26 through the teacher interface 30. The information can include percent correct and which words were misspelled so that a teacher may determine if a student consistently misspells any specific word pattern. Further, the teacher is provided with information on how words are misspelled along with a category of the misspelled words. Such information can be used by the teacher to determine patterns and target individualized instruction for a student based not only on what words are misspelled, but how they are misspelled.

Future tests 22 for a student include the misspelled words from previous tests 22 on subsequent tests 22 and word lists 14. Moreover, as additional words are misspelled, they are included in current working word lists 14 until the student demonstrates an ability to spell the words correctly. Further, the words from a similar category as those misspelled can be added to subsequent word lists 14 to further aid the student in mastering spelling of words with a similar pattern and grade level.

The system 10 is further programmed and designed to insert previously misspelled words that were then spelled correctly to reinforce mastery of spelling of that word and category of words. A percentage of these previously misspelled words can be applied to ensure mastery of that word and/or pattern of spelling. For example, if a student were to misspell previously correctly spelled words at a rate greater than 15%, additional work and words in that category could be added to future word lists 14 to reinforce mastery of the word and word grouping.

The teacher utilizes the system 10 to monitor progress of each student and identify patterns for each student, or group of students. This information enables the teacher to tailor instruction to each student and detect patterns to further tailor and modify instruction to address problems with specific words, word patterns or grade level. Information on the type and ways words are misspelled is used to reorder future word lists 14 and instruction to address problem areas.

The system 10 may also link specific musical note to each letter of the alphabet. The link to the musical note would provide an alternate communication to the student of the proper spelling of the word. Moreover, the system 10 could also vocalize the sound each time a letter is typed within a quiz, testing or other activities that are done with the spelling words.

The information is capable of being combined and sorted in many different ways. Information can be sorted and categorized by student, age, class and word mastery levels. This information enables the teacher to create additional word lists 14 that address difficulties and/or recognize strengths. For example data gathered from 8 year olds spelling at a 5^{th} grade level may be significantly different from 10 year olds spelling at the same grade level. Accordingly, the data manipulation and sorting possible with the disclosed system 10 enables the creation of word lists 14 by ability level for each age group. The age group and grade levels can be divided in any way desired such as by half grade levels and age groups in 6 month increments. Moreover, different regions of the country and world may also use different word lists 14 that are unique to a geographic location to reflect spelling competency differences by region, state, country or other geographic division.

The system 10 includes many different activities 20 that can be worked on at the website through the student interface 28 and/or that may be printed out for use away from a computer 32. The system 10 may also include a virtual reward system 10 to recognize mastery of different levels of spelling and/or vocabulary.

Teaching and working on vocabulary is similar to the spelling word process in that a specific category is selected and tailored to each student or group of students. The vocabulary portion of the system 10 would further include pictures and descriptions on how to properly utilize a word or phrase. The student would then be tested by being presented with several different sentences utilizing the word or phrase differently and/or an array of pictures depicting the word meaning from which the student would select the sentence and/or picture that correctly utilizes the word or phrase. The teacher would then be able to review progress for each student and identify problem areas for each student or group of students as is done with the spelling words.

The system 10 may also include features to aid students with special needs such as visual or hearing impairments. The system 10 includes video or animation information of a human face or mouth speaking the words to aid hearing impaired students. Such features can be provided for the word lists 14 during testing and during the various learning activities 20. The video and/or animations can be utilized to show a face with a mouth moving to speak the words to aid in hearing impaired students. Such features can be implemented for all parts of the system 10 including testing and activities 20. The hearing impaired is aided by seeing the proper movement of the mouth to create the different sounds required for speaking a word.

Referring to FIG. 2, one embodiment of the disclosed method is schematically shown at 34 and includes the initial step of inputting information relating to individual and/or groups of students into a system 10 including a database 12 as indicated at 36. The method continues with students accessing the system 10 and database 12 through a student interface 28 as is indicated at 38. The students are tested by individual and/or group of students to determine an initial level of competency and ability as is indicated at 40. Once the competency and ability level is determined, a word list 14 for study based on the level of competency and ability is formulated and determined based on the testing as is indicated at 42. The testing also provides for identification of words by word pattern and/or grade level and defining the word list 14 to include words within the identified pattern and grade level as is schematically indicated at 44.

The students study words and/or vocabulary through activities 20 accessed as provided in the system 10 as is shown at 46. The teacher through the teacher interface 30 is enabled to track progress of a student and/or group of students and demonstrated competency and ability as indicated at 48. The tracking of progress enables the teacher to tailor subsequent word lists 14, and activities 20 based upon the progress tracked and documented in the system 10 and database 12 as is shown at 50. The system and method loops back through tracking of progress 48 and/or the tailoring subsequent word list steps 50 throughout the school year and/or instruction period to continually advance and improve a student's competency and ability.

It should be understood, that the disclosed method of system 10 for teaching spelling and vocabulary is performed as part of a computing device used to implement various functionality, of the system 10 and database 12. In terms of hardware architecture, such a computing device can include a processor, a memory, and one or more input and/or output (I/O) device interface(s) that are communicatively coupled via a local interface. The local interface can include, for example but not limited to, one or more buses and/or other wired or wireless connections. The local interface may have additional elements, which are omitted for simplicity, such as controllers, buffers (caches), drivers, repeaters, and receivers to enable communications. Further, the local interface may include address, control, and/or data connections to enable appropriate communications among the aforementioned components.

The processor may be a hardware device for executing software, particularly software stored in memory. The processor can be a custom made or commercially available processor, a central processing unit (CPU), an auxiliary processor among several processors associated with the computing device, a semiconductor based microprocessor (in the form of a microchip or chip set) or generally any device for executing software instructions.

The memory can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). Moreover, the memory may incorporate electronic, magnetic, optical, and/or other types of storage media. Note that the memory can also have a distributed architecture, where various components are situated remotely from one another, but can be accessed by the processor.

The software in the memory may include one or more separate programs, each of which includes an ordered listing of executable instructions for implementing logical functions. A system component embodied as software may also be construed as a source program, executable program (object code), script, or any other entity comprising a set of instructions to be performed. When constructed as a source program, the program is translated via a compiler, assembler, interpreter, or the like, which may or may not be included within the memory.

The Input/Output devices that may be coupled to system I/O Interface(s) may include input devices, for example but not limited to, a keyboard, mouse, scanner, microphone, camera, proximity device, etc. Further, the Input/Output devices may also include output devices, for example but not limited to, a printer, display, etc. Finally, the Input/Output devices may further include devices that communicate both as inputs and outputs, for instance but not limited to, a modulator/demodulator (modem; for accessing another device, system, or network), a radio frequency (RF) or other transceiver, a telephonic interface, a bridge, a router, etc.

When the computing device is in operation, the processor can be configured to execute software stored within the memory, to communicate data to and from the memory, and to generally control operations of the computing device pursuant to the software. Software in memory, in whole or in part, is read by the processor, perhaps buffered within the processor, and then executed.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A computer implemented method for teaching and evaluating language competency comprising:
inputting information relating to at least one student into a computing system including a database;
testing the at least one student to determine an initial level of competency and ability utilizing the computing system;
defining a word list for study based on the level of competency and ability determined during testing;
tracking progress of a student demonstrated competency and ability; and
tailoring subsequent word lists based on the progress tracked and documented in the system and database.

2. The method as recited in claim 1, including accessing the system and database through a student interface and testing the at least one student through the student interface to the computer system.

3. The method as recited in claim 1, identifying words with the database by a common characteristic and defining the word list to include words with the common characteristic.

4. The method as recited in claim 3, wherein the common characteristic comprises at least one of an identified pattern and grade level and defining the word list to include words within one of the identified pattern and grade level.

5. The method as recited in claim 1, including defining activities for studying words based on the defined word list and monitoring student progress through a teacher interface of the computer system.

6. The method as recited in claim 5, including defining activity that provides an audible prompt for a student to input a word to the system to demonstrate an understanding of a meaning of a selected word from the defined word list.

7. The method as recited in claim 1, wherein the at least one student comprises a group of students.

8. The method as recited in claim 1, wherein tracking progress includes reviewing tests administered through the system to the at least one student.

9. The method as recited in claim 1, wherein tailoring subsequent word lists includes defining a new word list that includes a common characteristic based on demonstrated competency tracked by the system for a previously defined word list.

10. A system for teaching spelling and vocabulary comprising:
a database accessible as part of computer system, wherein the database includes listings of words categorized by common characteristics and data sortable by student that is indicative of progress relating to student mastery of the listing of words;
a student interface for providing accessing by a student to the database; and
a teacher interface to the database for providing access by a teacher to input student information and track mastery of the listing of words, wherein the teacher interface to the database includes reports for defining and categorizing data resulting from activities and testing conducted by students to determine progress and for tailoring future word lists based on determined progress.

11. The system as recited in claim 10, wherein the database includes information indicative of student mastery that may be utilized to identified problem areas, wherein the identified problem areas are based on the categorized common characteristics of the listing of words.

12. The system as recited in claim 10, wherein the database, student interface and teacher interface are part of a web based application.

13. The system as recited in claim 10, wherein the common characteristics include at least one of a grade level, an ability level, age level and word pattern.

14. The system as recited in claim 10, wherein the student interface includes activities based on a selected listing of words and tailored to student mastery identified during an initial test.

15. The system as recited in claim 10, wherein the student interface includes access to tests based on the word lists for determining a student mastery of a listing of words with a common characteristic.

16. The system as recited in claim 15, wherein the system includes a device for generating an audio signal for prompting students to input a selected word from a selected word listing to demonstrate mastery.

17. A computer readable storage medium containing a plurality of computer executable instructions for teaching and evaluating language competency comprising:
a first set of instructions directing a computer to prompt inputting information relating to at least one student into a computing system including a database;
a second set of instructions directing a computer in administering testing of the at least one student to determine an initial level of competency and ability utilizing the computing system;
a third set of instructions for directing a computer to define a word list for study based on the level of competency and ability determined during testing;
a fourth set of instructions directing a computer to track progress of a student demonstrated competency and ability; and
a fifth set of instructions directing a computer to tailor subsequent word lists based on the progress tracked and documented in the system and database.

18. The storage medium as recited in claim 17, including an additional set of instructions for directing the computer to identify words within the database by a common characteristic and define a word list to include words with the common characteristic.

19. The storage medium as recited in claim 18, including an additional set of instructions directing the computer to define activities that provides an audible prompt for a student to input a word to the system to demonstrate an understanding of a meaning of a selected word from the defined word list.

20. The storage medium as recited in claim 17, including an additional set of instructions directing the computer to define subsequent word lists to include a new word list that includes a common characteristic based on demonstrated competency tracked by the system for a previously defined word list.
